(19) United States
(12) Patent Application Publication
(10) Pub. No.: US 2017/0249023 A1
(43) Pub. Date: Aug. 31, 2017

(54) SOUND CONTROLLED LIGHT PEN

(71) Applicant: Golden Right Company Ltd., New Taipei City (TW)

(72) Inventor: Te-Hsiang FANG, New Taipei City (TW)

(21) Appl. No.: 15/053,893

(22) Filed: Feb. 25, 2016

(51) Int. Cl. G06F 3/0354

(52) U.S. Cl. CPC G06F 3/03542

(57) ABSTRACT

A sound controlled light pen includes a main body and a sound controlled light emitting structure. The main body includes a pen barrel and a cartridge installed in the pen barrel. The sound controlled light emitting structure is connected to the pen barrel and includes a casing with a transparent portion, a transparent film covered onto the transparent portion, a microphone, a light emitting element, and a controller. The casing A further contains a circuit board provided for installing and electrically connecting the microphone that senses a change of sound and generates a sense signal, the light emitting element that is configured to be corresponsive to the transparent portion, and the controller that controls the light emitting element to emit light after receiving the controller sense signal, so that the sound controlled light pen and the sound controlled light emitting structure have excellent interactions with each other.

### FIELD OF THE INVENTION

The technical field relates to ornaments or stationery with sound controlled and light emitting functions, and more particularly to a sound controlled light pen.

### BACKGROUND OF THE INVENTION

As the quality of life improves, people have growing emphasis on entertainment, so that various cute, healing, and characteristic ornaments and stationery are available in the market, and these ornaments and stationery add environmental atmosphere and fun to improve people's willingness to buy.

However, most of the ornaments or stationery are focused on stylish design only, and seldom come with sound and light effects. Even if they come with sound and light, they simply play music or flash light when pressing a button, and generally do not interact with users. Therefore, it is a main point for this disclosure to provide an ornament or stationery that interacts with users.

In view of the aforementioned problems of the prior art, the discloser of this disclosure based on years of experience in the related industry to conduct extensive researches and experiments, and finally provided a feasible solution to overcome the problems of the prior art.

### SUMMARY OF THE INVENTION

It is a primary objective of this disclosure to provide a sound controlled light pen having a microphone for sensing a change of sound to generate a sense signal and a controller for receiving the sense signal and controlling the light emission of a light emitting element, so that the sound controlled light pen and the sound controlled light emitting structure will give a light effect after receiving a user's sound, and the sound controlled light pen and the sound controlled light emitting structure provide an interactive effect with the user.

To achieve the aforementioned and other objectives, this disclosure provides a sound controlled light pen, comprising: a main body, including a pen barrel and a cartridge installed in the pen barrel; and a sound controlled light emitting structure, coupled to the pen barrel, and including: a casing, having a transparent portion; a transparent film, covered onto the transparent portion; a circuit board, contained in the casing; a microphone, installed and electrically coupled to the circuit board, for sensing a change of sound and generating a sense signal; a light emitting element, installed and electrically coupled to the circuit board, and configured to be corresponsive to the transparent portion; and a controller, installed and electrically coupled to the circuit board, for controlling the light emitting element to emit light after receiving the sense signal.

This disclosure has the following effects: The transparent film is covered onto the transparent portion, so that when the light emitting element does not emit light, the appearance of the sound controlled light emitting structure and the sound controlled light pen just shows the pattern or color of the transparent film, and when the light emitting element emits light, the light of the light emitting element passes through the transparent film and shows the design of the patterned through slot, so as to improve the amusement of the sound controlled light emitting structure and the sound controlled light pen.

### BRIEF DESCRIPTION OF THE DRAWINGS

FIG. 1 is a perspective view of a sound controlled light pen of this disclosure;

FIG. 2 is an exploded view of a sound controlled light pen of this disclosure;

FIG. 3 is a sectional view of a sound controlled light pen of this disclosure; and

FIG. 4 is a sectional view of a sound controlled light pen another embodiment of this disclosure.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and figures disclosed herein are to be considered illustrative rather than restrictive.

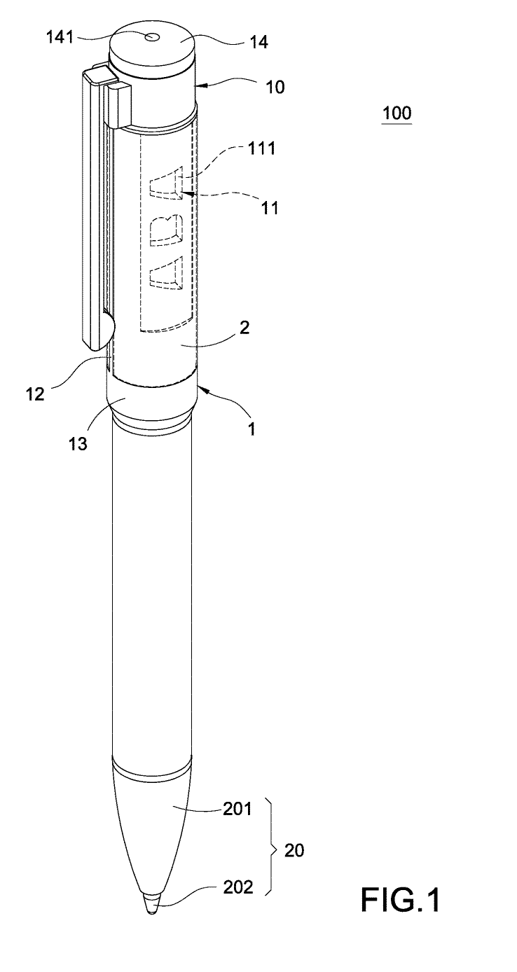

With reference to FIGS. 1 to 3 for a sound controlled light pen of this disclosure, the sound controlled light pen 100 comprises a main body 20 and a sound controlled light emitting structure 10, and the sound controlled light emitting structure 10 further comprises a casing 1, a transparent film 2, a circuit board 3, a microphone 4, a light emitting element 5 and a controller 6.

In FIGS. 1 to 3, the main body 20 comprises a pen barrel 201, a cartridge 202 installed in the pen barrel 201, and a first thread 2011 formed at a top end of the pen barrel 201.

In FIGS. 1 to 3, the casing 1 comprises a transparent portion 11, and specifically the casing 1 comprises a circular wall 12, and the transparent portion 11 further comprises one or more patterned through slots 111 formed on the circular wall 12. Wherein, the patterned through slot 111 is in the shape of a number, an alphabet, or a Chinese character, or in a geometric shape of a circle, a triangle, a square, or a polygon.

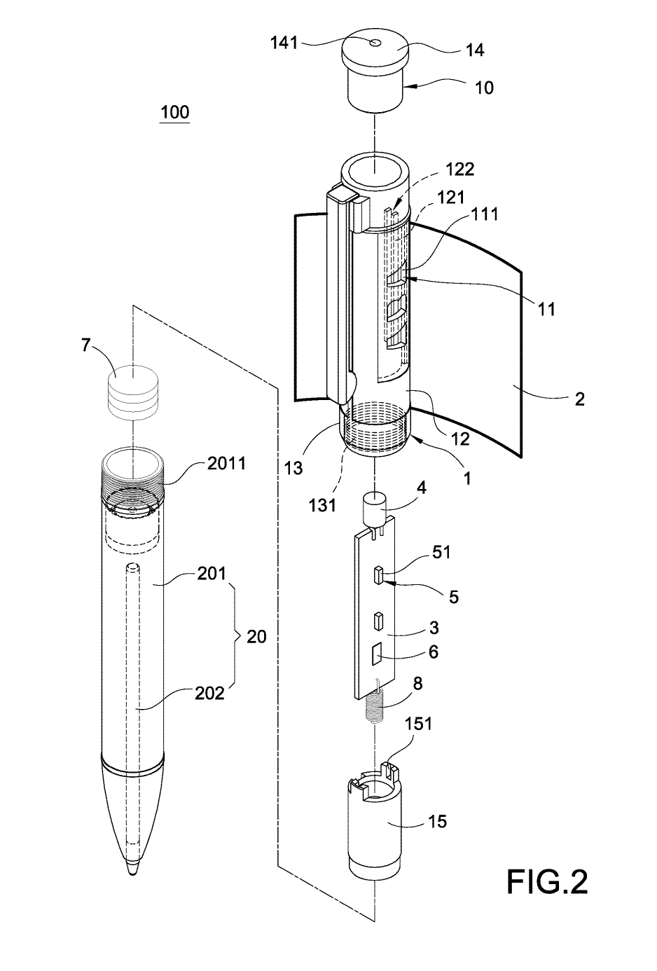

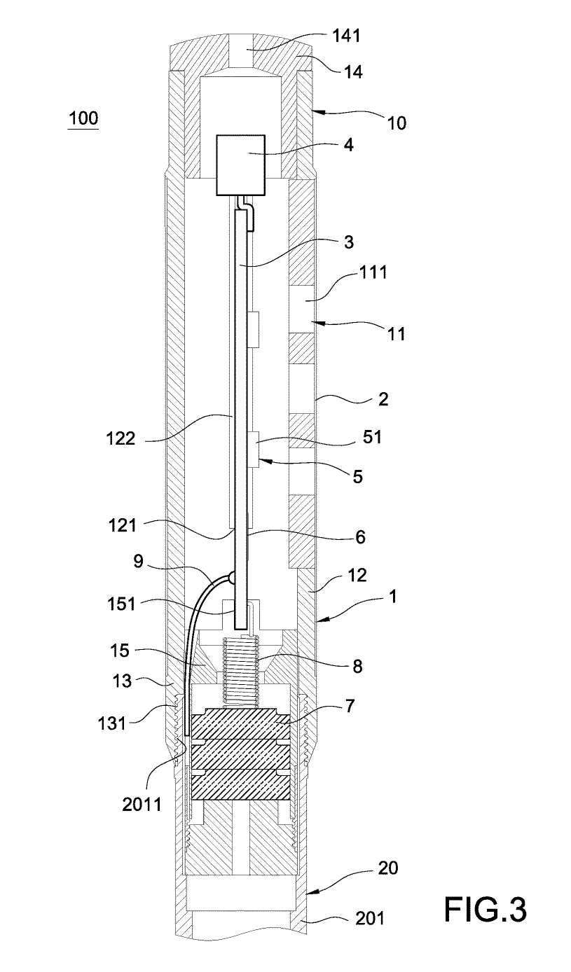

In FIGS. 2 and 3, the circular wall 12 includes two recessed latch grooves 121 formed therein, and the circular wall 12 includes two pairs of long ribs 122 extended from the circular wall 12, and the casing 1 is a hollow pipe 13 having a second thread 131 formed at the bottom of the hollow pipe 13 for detachably screwed and coupled to a first thread 2011, so that the sound controlled light emitting structure 10 can be coupled to the pen barrel 201.

In FIGS. 2 and 3, the sound controlled light emitting structure 10 further comprises a plug cover 14 and a positioning block 15, and the plug cover 14 is plugged into the top of the hollow pipe 13, and the plug cover 14 has a sound receiving hole 141, and the positioning block 15 is installed and fixed into the casing 1, and the positioning block 15 has two jacks 151 installed under the two pairs of long ribs 122 respectively, and each recessed latch groove 121 is formed between each pair of the long ribs 122 and each jack 151.

In FIGS. 1 to 3, the transparent film 2 is covered onto the transparent portion 11. Specifically, the transparent film 2 is disposed around the circular wall 12 to cover the patterned through slot 111.

In FIGS. 2 and 3, both sides of the circuit board 3 are latched and positioned at the two recessed latch grooves 121 respectively, so that the circuit board 3 is contained in the casing 1.

In FIGS. 2 and 3, the microphone 4 is installed and electrically coupled to circuit board 3 for sensing a change of sound (such as “Happy Birthday”, “I Love You”, or any sentence set by users into the product) and generating a sense signal. Wherein, the microphone 4 is configured to be proximate to the sound receiving hole 141 for receiving sound more conveniently and clearly.

In FIGS. 2 and 3, the light emitting element 5 is installed and electrically coupled to the circuit board 3 and configured to be corresponsive to the transparent portion 11. Specifically, the light emitting element 5 includes a plurality of light emitting diodes 51 installed on the circuit board 3 and configured to be corresponsive to the transparent portion 11.

In FIGS. 2 and 3, the controller 6 is installed and electrically coupled to the circuit board 3 for controlling the light emitting element 5 to emit light after receiving the sense signal.

In FIGS. 2 and 3, the sound controlled light emitting structure 10 further comprises a battery 7, a conductive spring 8 and an electric wire 9, and the battery 7 is installed in the pen barrel 201, and the conductive spring 8 is fixed and coupled to the circuit board 3, clamped between the circuit board 3 and the battery 7, and electrically coupled to the circuit board 3 and the battery 7, and both ends of the electric wire 9 are respectively and electrically coupled to the circuit board 3 and the battery 7, so that the battery 7 can supply electric power to the circuit board 3.

In FIGS. 2 and 3, the sound controlled light pen 100 of this disclosure comprises: a main body 20 including a pen barrel 201 and a cartridge 202 installed in the pen barrel 201, and the sound controlled light emitting structure 10 is coupled to the pen barrel 201, and the casing 1 has a transparent portion 11; a transparent film 2, covered onto the transparent portion 11; a circuit board 3, installed in the casing 1; a microphone 4 installed and electrically coupled to the circuit board 3, for sensing a change of sound and generating a sense signal; a light emitting element 5, installed and electrically coupled to the circuit board 3 and configured to be corresponsive to the transparent portion 11; a controller 6, installed and electrically coupled to the circuit board 3, for controlling the light emitting element 5 to emit light after receiving the sense signal.

When a user sets a sentence such as “Happy Birthday” or “I Love You” to the product, the microphone 4 senses the sound of “Happy Birthday” or “I Love You” to generate a sense signal, and the controller 6 controls the light emitting element 5 to emit light after receiving the sense signal, so that the sound controlled light pen 100 and the sound controlled light emitting structure 10 produce a light effect after receiving the sentence set to the product, so as to improve the interaction and amusement between the product of this disclosure and the users.

In addition, the sound controlled light emitting structure 10 of this disclosure is not limited to be installed in the pen barrel 201 only, but the sound controlled light emitting structure 10 may also be an ornament such as a strap, a doll or a photo frame. In a preferred embodiment of this disclosure, the sound controlled light emitting structure 10 is installed to the pen barrel 201 to be assembled to form a sound controlled light pen 100. Therefore, the sound controlled light pen 100 not just provides the original writing function only, but also provides more fun to the interaction and amusement between the product and the users.

In addition, the transparent film 2 is covered onto the transparent portion 11, so that when the light emitting element 5 does not emit light, the appearance of the sound controlled light emitting structure 10 and the sound controlled light pen 100 just shows the pattern or color of the transparent film 2 only. When the light emitting element 5 emits light, the light of the light emitting element 5 passes through the transparent film 2 and shows the design of the patterned through slot 111, so as to improve the amusement of the sound controlled light emitting structure 10 and the sound controlled light pen 100.

In addition, the interior of the circular wall 12 has two recessed latch grooves 121, and both sides of the circuit board 3 are latched and positioned at the two recessed latch grooves 121 respectively, and a first thread 2011 is formed at the top of the pen barrel 201, and a second thread 131 is formed at the bottom of the casing 1, and the first thread 2011 and the second thread 131 may be detachably screwed and coupled to each other, so that the sound controlled light pen 100 can be installed, removed, or maintained more conveniently.

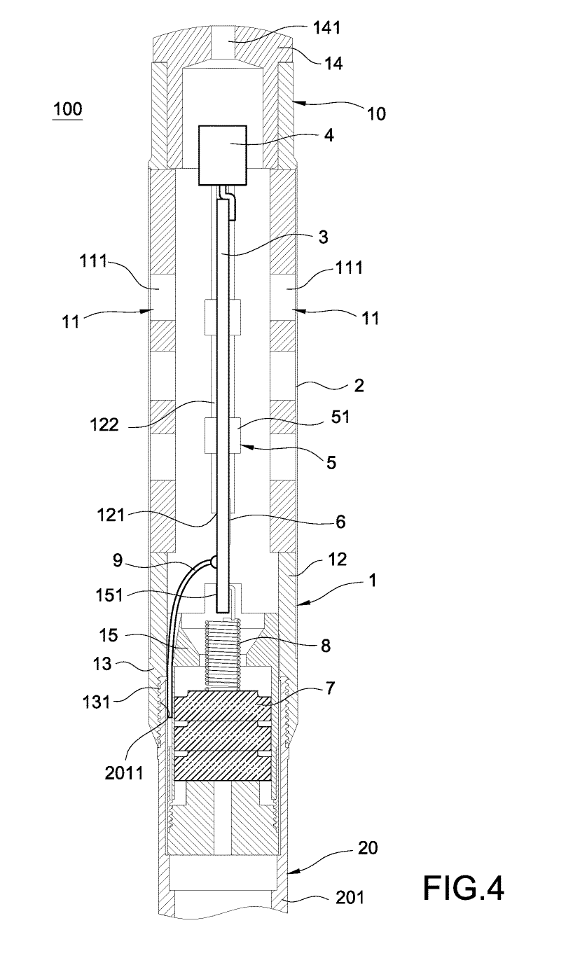

With reference to FIG. 4 for a sound controlled light pen 100 and a sound controlled light emitting structure 10 in accordance with another embodiment of this disclosure, this embodiment is substantially the same as the embodiment as shown in FIGS. 1 to 3 except that there are two transparent portions 11 in this embodiment.

Specifically, the two transparent portions 11 are disposed on two opposite sides of the casing 1 respectively, and the light emitting diodes 51 are installed on two opposite sides of the circuit board 3 respectively, and the light emitting diodes 51 on one of the sides of the circuit board 3 are configured to be corresponsive to one of the transparent portions 11, and the light emitting diodes 51 on the other side of the circuit board 3 are configured to be corresponsive to the other transparent portion 11, so that the sound controlled light pen 100 and the sound controlled light emitting structure 10 have the feature of expressing in more visual directions and angles.

While this disclosure has been described by means of specific embodiments, numerous modifications and variations could be made thereto by those skilled in the art without departing from the scope and spirit of this disclosure set forth in the claims.

What is claimed is:

1. A sound controlled light pen, comprising:
a main body, including a pen barrel and a cartridge installed in the pen barrel; and
a sound controlled light emitting structure, coupled to the pen barrel, and further comprising:
a casing, having a transparent portion;
a transparent film, covered onto the transparent portion;
a circuit board, contained in the casing;
a microphone, installed and electrically coupled to the circuit board, for sensing a change of sound to generate a sense signal;
a light emitting element, installed and electrically coupled to the circuit board, and configured to be corresponsive to the transparent portion; and
a controller, installed and electrically coupled to the circuit board, for controlling a light emission of the light emitting element after receiving the sense signal.

2. The sound controlled light pen according to claim 1, wherein the pen barrel has a first thread formed at a top end of the pen barrel, and the casing is a hollow pipe having a second thread formed at a bottom end of the hollow pipe, and the first thread and the second thread are detachably screwed with each other.

3. The sound controlled light pen according to claim 2, wherein the sound controlled light emitting structure further comprises a plug cover plugged onto the top end of the hollow pipe, and the plug cover has a sound receiving hole, and the microphone is configured to be proximate to the sound receiving hole.

4. The sound controlled light pen according to claim 2, wherein the sound controlled light emitting structure further comprises a battery, a conductive spring, and an electric wire, and the battery is contained in the pen barrel, and the conductive spring is fixed to the circuit board, clamped between the circuit board and the battery and electrically coupled to the circuit board and the battery, and both ends of the electric wire are respectively and electrically coupled to the circuit board and the battery.

5. The sound controlled light pen according to claim 1, wherein the casing has a circular wall, and the transparent portion includes at least one patterned through slot formed on the circular wall, and the transparent film is disposed around and covered onto the circular wall and provided for covering the patterned through slot.

6. The sound controlled light pen according to claim 1, wherein the light emitting element includes a plurality of light emitting diodes installed on the circuit board and configured to be corresponsive to the transparent portion.

7. The sound controlled light pen according to claim 6, wherein the casing has a circular wall, and the circular wall has two recessed latch grooves formed therein, and both sides of the circuit board are latched and positioned to the two recessed latch grooves respectively.

8. The sound controlled light pen according to claim 7, wherein the sound controlled light emitting structure further comprises a positioning block installed and fixed in the casing, and two pairs of long ribs extended from the interior of the circular wall, and the positioning block includes two jacks disposed under the two pairs of long ribs respectively, and each of the recessed latch grooves is formed between each respective pair of long ribs and each respective the jack.

9. The sound controlled light pen according to claim 6, wherein transparent portion comes with a quantity of two, and the two transparent portions are disposed on two opposite sides of the casing respectively, and the light emitting diodes are installed on two opposite sides of the circuit board and configured to be corresponsive to the two transparent portions respectively.
